(19) United States
(12) Patent Application Publication
(10) Pub. No.: US 2013/0117940 A1
(43) Pub. Date: May 16, 2013

(54) UPHOLSTERY PANELS WITH FIRE RESISTANT BACKING LAYER

(71) Applicant: Precision Fabrics Group, Inc., Greensboro, NC (US)

(72) Inventors: Walter Gomer Jones, Greensboro, NC (US); James Douglas Small, Greensboro, NC (US); John H. Walton, Greensboro, NC (US); Alfred Frank Baldwin, Greensboro, NC (US); Zareh Mikaelian, Greensboro, NC (US)

(73) Assignee: Precision Fabrics Group, Inc., Greensboro, NC (US)

(21) Appl. No.: 13/732,903

(22) Filed: Jan. 2, 2013

Related U.S. Application Data
(63) Continuation of application No. 11/018,772, filed on Dec. 21, 2004, now abandoned.
(60) Provisional application No. 60/606,625, filed on Sep. 2, 2004.

(51) Int. Cl. A47C 31/00

(52) U.S. Cl. CPC A47C 31/001
USPC 5/698

(57) ABSTRACT

A composite upholstery panel includes a layer of ticking fabric, a layer of flame and heat-resistant backing fabric, and a layer of resilient flame and heat-resistant cushioning material sandwiched between the layer of ticking fabric and the layer of backing fabric. The composite upholstery panel maintains flame and heat resistant integrity when impinged at any location with a gas flame in accordance with testing protocol set forth in Technical Bulletin 603 of the State of California Department of Consumer Affairs (TB-603). However, individually, the ticking layer, backing layer and cushioning layer would fail to maintain flame and heat resistant integrity when impinged with a gas flame in accordance with testing protocol set forth in TB-603.

### RELATED APPLICATIONS

This application is a continuation application of U.S. application Ser. No. 11/018,772, filed Dec. 21, 2004 which claims the benefit of U.S. Provisional Application No. 60/606,625 filed Sep. 2, 2004, the disclosures of which are incorporated herein by reference in their entirety as if set forth fully herein.

### FIELD OF THE INVENTION

The present invention relates generally to fire prevention and, more particularly, to rendering upholstered articles fire resistant.

### BACKGROUND OF THE INVENTION

There is heightened awareness of fire prevention in homes and businesses in the United States. This awareness has led to the development of standards and legislation directed to reducing the risk of fires, particularly with respect to bedding and upholstered furniture. Conventional fire prevention techniques for bedding and upholstered furniture involve the topical application of flame retardant chemicals directly to an outer decorative layer of upholstery material.

However, recently passed legislation may render conventional fire protection techniques for bedding (particularly mattresses) inadequate. For example, the cigarette burn test for measuring flame resistance (developed by the Upholstered Furniture Action Council) has been deemed inadequate by the state of California and by the U.S. Consumer Product Safety Commission. In addition, new regulations being promulgated in some states prohibit the sale or manufacture of mattresses that do not pass these new flammability tests.

For example, California Technical Bulletin 603 of the State of California Department of Consumer Affairs (hereinafter “TB-603”), which is incorporated herein by reference in its entirety, exposes the top and side panels of a mattress to an open gas flame to simulate the effects of burning bedclothes. TB-603 is extremely aggressive relative to conventional cigarette burn test and many industry analysts are skeptical that conventional upholstered furniture and bedding products (e.g., mattresses, etc.) will be able to pass TB-603.

In addition, material that can prevent the propagation of flame into the core cushioning material of furniture, and institutional bedding is desired. California Technical Bulletin 117 of the State of California Department of Consumer Affairs (hereinafter “TB-117”), which is incorporated herein by reference in its entirety, provides testing for upholstered furniture, and California Technical Bulletin 129 of the State of California Department of Consumer Affairs (hereinafter “TB-129”), which is incorporated herein by reference in its entirety, provides testing for institutional bedding.

In some cases, even though an upholstery fabric or ticking is constructed of inherently flame resistant material, it may be permeable such that heat and hot gases may be transmitted through the fabric causing internal materials to ignite. Furthermore, conventional methods of assembling mattresses and upholstered furniture may produce seams and joints that cannot withstand these new flammability tests without splitting open and subjecting flammable interior materials to flame. Also, pores formed in bedding fabrics as a result of sewing, seaming, quilting, and/or the attachment of labels, handles, decorations, vents, etc., may be penetrated by flames and hot gases which may result in the combustion of interior materials.

The top and side panels of a mattress are typically composed of layers of material. Typically the outer layer is a decorative ticking fabric that is a high quality knit or woven textile. The next layer is typically a cushioning layer, such as foam, batting, or other lofty, soft material. The cushioning layer provides a plump, soft, feel and texture to the panel. The next layer is typically a backing fabric that supports the cushioning material and provides strength and dimensional stability to the panel. The backing layer is conventionally a polyester or polypropylene nonwoven fabric, a knit, or a woven fabric. The layers of a mattress panel are typically assembled, for example, with stitch quilting, ultrasonic quilting, or are glued, bonded, heat bonded, or simply laid into a structure and attached at the seams. Conventionally, a flame and heat blocking component is added to the panel when the panel is designed to resist heat, fire, or ignition.

To prevent the ignition of the core of a mattress, or other upholstered article, a variety of flame resistant materials have been utilized in the construction of top and side panels for mattresses. For example, fabrics made from graphite, carbon, para-aramid, or other flame and heat resistant fibers have been used. Batting composed of flame resistant fibers or fibers that char, such as silica modified rayon (or Visil), modacrylic, FR rayon, FR polyester, melamine, or other suitable fibers may be produced that at high basis weights can provide flame resistance and insulation. Foams may be chemically treated with flame retardant or impregnated with graphite. Fabrics may also be treated with flame retardant and/or intumescent chemical compositions or impregnated with intumescent chemicals to provide flame blocking and insulative properties.

Unfortunately, when flame and heat resistance is achieved through the use of a batting of flame resistant fibers, the amount of batting material that is required to provide the flame resistance is significantly higher than the amount that would generally be needed to provide cushioning, texture, and aesthetics. In many cases as much as twice the amount of fibrous batting is required to provide the flame resistance than is required to provide cushioning. While a normal amount of fibrous batting would be around 4 to about 6 ounces per square yard, 9 ounces per square yard, or more can be required for flame resistance. This has the consequences of forcing an “overstuffed” appearance, which may make sewing and construction difficult, and which may add significant costs to mattress construction.

In addition, the use of thermoplastic backing fabrics in mattress construction, such as a polypropylene spunbonded nonwoven, may result in the melting and shrinking away of the backing fabric when exposed to heat and/or flame. This shrinking or opening force can draw cracks and holes into the mattress structure when the mattress is exposed to high heat. Additionally, molten thermoplastic can soak into the cushioning material and increase flammability of the mattress. Often a fire can enter from beneath a mattress or foundation, or upholstered furniture, and propagate across the inside surface of the flame resistant panel.

### SUMMARY OF THE INVENTION

In view of the above discussion, a composite upholstery panel, according to embodiments of the present invention, includes a layer of ticking fabric, a layer of flame and heat-resistant backing fabric, and a layer of resilient flame and heat-resistant cushioning material sandwiched between the layer of ticking fabric and the layer of backing fabric. The three layers are assembled into a composite upholstery panel, for example, using quilting, stitching, ultrasonic bonding, thermal bonding or adhesive.

The backing layer may be made from flame resistant fibers, or from non thermoplastic fibers and then finished or coated to provide flame resistant properties. Alternatively, blends of flame resistant fibers, non thermoplastic fiber, and a minor component of thermoplastic fiber can be used. The cushioning layer may be constructed of various flame resistant fibers including, but not limited to, aramid, modacrylic, silica modified rayon, melamine, carbon, and others or blends of flame resistant fibers. Alternatively, flame resistant fibers with minor blend components such as polyester binder fiber may be used. Alternatively, the cushioning layer may be composed of non thermoplastic fiber such as cellulose or wool, that is treated chemically for flame resistance. An example of this material would be a cotton batting that has been impregnated with boric acid. The ticking layer may be constructed of flame resistant fiber or coated with flame resistant chemicals, for example.

The composite upholstery panel will provides superior flame resistance due to the synergistic response of the three layers. For example, the composite upholstery panel is configured to maintain flame and heat resistant integrity when impinged at any location with a gas flame in accordance with testing protocol set forth in Technical Bulletin 603 of the State of California Department of Consumer Affairs (TB-603). However, individually, the ticking layer, backing layer and cushioning layer would fail to maintain flame and heat resistant integrity when impinged with a gas flame in accordance with testing protocol set forth in TB-603.

Conventional mattress and other upholstery panels traditionally have a backing layer formed from a fabric that is not flame resistant. When conventional backing layer fabric is replaced by fabric according to embodiments of the present invention, a synergistic effect is created that allows the cushioning layer and the ticking layer to have reduced cost and weight, which allows mattress and furniture manufacturers greater styling latitude. The ticking layer is the surface layer of a mattress or upholstered article that is used to add style, color and handle. If the ticking layer must be flame resistant in order for a composite panel (i.e., ticking layer, cushioning layer and backing layer, etc.) to maintain flame and heat resistant integrity in accordance with various testing protocols, then the variations in style construction, and fiber choice can be severely limited. Additionally, if a cushioning layer must supply all of the flame resistance, then it is often heavier and thicker than desirable, and will contain fibers that are not as soft, resilient, or durable. Moreover, mattresses and upholstered articles will be less comfortable, and may take a “set” or a permanent indentation in the cushion. Therefore, when a mattress or upholstered article is constructed for flame resistance, the use of a flame resistant backing fabric for the upholstered panels creates a system where the outer ticking fabric and the cushioning layer can be more creatively styled, and then the finished panel will provide flame resistance at the lowest cost and the least sacrifice of quality, appearance, and cushioning performance.

According to embodiments of the present invention, a mattress includes a mattress core having opposite upper and lower portions. An upper composite upholstery panel overlies the mattress core upper portion, and a side composite upholstery panel extends around a periphery of the mattress core. The side composite upholstery panel is attached along an edge portion to the upper composite upholstery panel. The upper and side composite upholstery panels each include a layer of ticking fabric, a layer of flame and heat-resistant backing fabric, and a layer of resilient flame and heat-resistant cushioning material sandwiched between the layer of ticking fabric and the layer of backing fabric. The upper and side composite upholstery panels each maintain flame and heat resistant integrity when impinged at any location with a gas flame in accordance with testing protocol set forth in TB-603. However, individually, the ticking layer, backing layer and cushioning layer would fail to maintain flame and heat resistant integrity when impinged with a gas flame in accordance with testing protocol set forth in TB-603.

### BRIEF DESCRIPTION OF THE DRAWINGS

FIG. 1 is a cross-sectional view of a composite upholstery panel, according to embodiments of the present invention.

FIG. 2 is a cross-sectional view of a mattress incorporating composite upholstery panels of FIG. 1.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like are used herein for the purpose of explanation only.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items. All publications, patent applications, patents, and other references mentioned herein are incorporated herein by reference in their entirety.

As used herein, the term “flame resistant material” means a material that passes the requirements of National Fire Protection Association (NFPA) 701-1989.

As used herein, the term “heat resistant material” means a material that does not melt, ignite, or decompose up to a temperature of 250° C. at ambient atmospheric oxygen levels.

According to embodiments of the present invention, composite upholstery panels for use within home and public building furnishings, such as upholstered furniture, bedding products (e.g., mattresses, futons, sleeping bags, cots, etc.), automotive, aircraft and boat seating and interiors, theater seating and decorations, and any other items where cushioning may be exposed to fire, are provided that can withstand the intense flames of various new state and federal tests and prevent underlying materials from igniting.

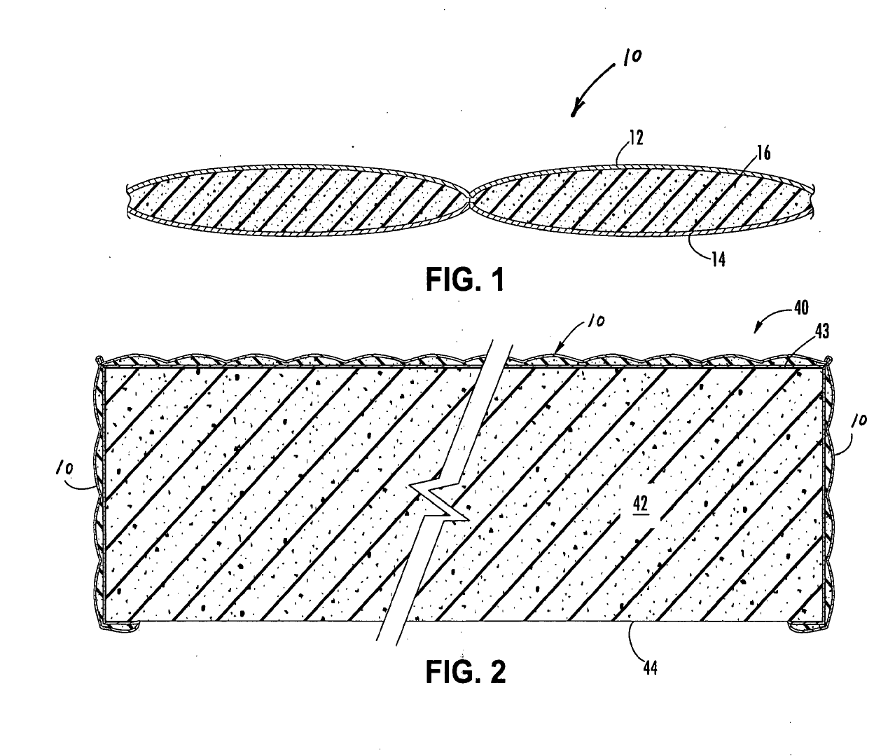

Referring now to FIG. 1, a composite upholstery panel 10, according to embodiments of the present invention, includes a layer of ticking fabric 12, a layer of flame and heat-resistant backing fabric 14, and a layer of resilient flame and heat-resistant cushioning material 16 sandwiched between the ticking layer 12 and the backing layer 14. The composite upholstery panel 10 maintains flame and heat resistant integrity when impinged at any location with a gas flame in accordance with testing protocol set forth in Technical Bulletin 603 of the State of California Department of Consumer Affairs (TB-603). However, individually, the ticking layer, backing layer and cushioning layer would fail to maintain flame and heat resistant integrity when impinged with a gas flame in accordance with testing protocol set forth in TB-603. Applicants have discovered that the novel combination of these three layers, as described herein, allows the composite upholstery panel 10 to maintain flame and heat resistant integrity when impinged at any location with a gas flame in accordance TB-603.

The ticking layer 12 is a decorative layer of strong fabric and may be, for example, a knit or a woven fabric. The ticking layer 12 may be formed from a flame resistant material and/or may be treated with flame retardant material. The cushioning layer 16 may be formed from various flame resistant lofty materials including flame resistant fibrous materials and flame resistant foam materials. Exemplary flame resistant fibrous materials include, but are not limited to, fibers such as aramid, modacrylic, silica modified rayon, FR rayon, FR polyester, melamine, carbon, and blends thereof. Polyester binder fibers may also be utilized within the cushioning layer 16. According to embodiments of the present invention, the cushioning layer 16 may include non-thermoplastic fibers (e.g., cellulose, wool, etc.) that are chemically treated for flame resistance. According to embodiments of the present invention, the cushioning layer 16 may include cotton fibers that are treated with flame retardant material. When formed from flame resistant foam, the cushioning layer 16 may contain intumescent material, such as graphite.

According to embodiments of the present invention, the backing layer 14 is a fibrous material that has been treated with flame retardant material. For example, the backing layer 14 may be impregnated, finished or coated with an intumescent material, such as graphite. Alternatively, the backing layer may be a flame resistant fibrous material.

Intumescent material that may be utilized in accordance with embodiments of the present invention for the cushioning layer 16 and backing layer 14 is configured to swell and char in the presence of a flame so as to form a barrier to the flame and to heat generated by the flame. Intumescent compounds in accordance with embodiments of the present invention may be organic materials or inorganic materials, and may be combined with a spumific or “blowing agent” to enhance foaming and insulation properties. Suitable intumescent materials include, but are not limited to, melamine, pentaerythritol, vermiculite, fluorocarbons, graphite, bentonite, clay, phosphated melamine, borated melamine, sugars, and polyols.

An intumescent coating may be applied to the cushioning layer 16 and backing layer 14 as a lightweight and porous foam or froth using conventional coating techniques such as a knife coater, a roll coater, spray coating, calendering, transfer coating or screen printing. Various intumescent compounds are known and one particular suitable class of intumescent compounds comprises a source of carbon (i.e., a carbonific compound), a catalyst, and a source of non-flammable gas (i.e., a foaming or blowing agent). Exemplary carbonific compounds include carbohydrates, proteins or polyfunctional alcohols such as starch, casein or pentaerythritol. On exposure to flame, the catalyst causes the carbonific compound to swell and char. Exemplary catalysts include inorganic acids such as boric, phosphoric, or sulfuric acid, or may include compounds which on decomposition form an inorganic acid such as mono- or diammonium phosphates, melamine, and urea.

The source of non-flammable gas for foaming an intumescent coating may be provided by the catalyst, for example if melamine is used as the catalyst, or alternatively be provided by a compound which upon exposure to a flame evolves the gas such as ammonia, carbon dioxide or hydrogen chloride. The intumescent composition may be compounded with binders and thickeners and the like to aid in the specific application of the coating. Additionally, conventional flame retardant fillers such as alumina trihydrate, silicates, kaolin, gypsum and hydrated clay may be added.

When material having an intumescent coating according to aspects of the present invention is exposed to high temperature and/or a flame, the intumescent coating reacts and swells to form a char which closes the pores of the coating itself and fills pores or interstices in the cushioning layer 16 and backing layer 14. The char is substantially incombustible and has cellular characteristics. The char thus acts as a flame barrier and limits the penetration of flames and hot gases.

Table 1 lists several intumescent products that may be used in accordance with embodiments of the present invention. Other available products may also be used. Although all of these products are proprietary compounds, they all use the intumescent mechanism described above. Some are designed to be applied as a coating, while others may be padded on the cushioning layer 16 or backing layer 14 fabric.

TABLE 1

| | Application | |
|---|---|---|
| Product | Method | Manufacturer |
| Spartan 982 | Coating | Spartan Flame Retardants |
| Glotard BFA | Pad | Glo-tex International, Inc. |
| Pyromescent 3901 | Coating | Amitech, Inc. |
| Unibond 1114 | Coating | Unichem, Inc. |
| Glotard FRC BJ-M | Coating | Glo-tex International, Inc. |
| Glotard W263A | Pad | Glo-tex International, Inc. |

Flame retardant chemistry that may be utilized in accordance with embodiments of the present invention for the ticking layer 12, cushioning layer 16, and backing layer 14 includes, but is not limited to: borates such as boric acid, zinc borate or borax; sulfamates; phosphates such as ammonium polyphosphate; organic phosphorous compounds; halogenated compounds such as ammonium bromide, decabromodiphenyl oxide, or chlorinated paraffin; inorganic hydroxides such as aluminum or magnesium hydroxide, antimony compounds, and silica or silicates.

Commercial products that may be used according to embodiments of the present invention are listed below in Table 2. This list includes several of the many possible commercial products that may be used as a flame retardant according to embodiments of the present invention. Other available products may also be used.

TABLE 2

| Product | Chemical Nature | Manufacturer |
|---|---|---|
| SPARTAN 590 | Organic/Inorganic | Spartan Flame |
| | Phosphate blend | Retardants |
| SPARTAN 880 | Organic/Inorganic | Spartan Flame |
| | Phosphate blend | Retardants |
| SPARTAN | Organic/Inorganic | Spartan Flame |
| AR371 | Phosphate blend | Retardant |
| APEX | Organic Phosphate | Apex Chemical |
| FLAMEPROOF | Ammonia Salt | Corporation |
| 487 | | |
| APEX | Organic Phosphate | Apex Chemical |
| FLAMEPROOF | Ammonia Salt | Corporation |
| 2477 | | |
| ANTIBLAZE N | Cyclic Phosphorous | Rhodia |
| | Compound | |
| ANTIBLAZE NT | Cyclic Phosphorous | Rhodia |
| | Compound | |
| GUARDEX | Phosphorous/ | Glo-tex |
| FRC-PHN | Nitrogen Derivatives | International, Inc. |
| GUARDEX | Proprietary Compound | Glo-tex |
| FRC HV-NF | | International, Inc. |
| PYROZYL PCN | Phosphoric Acid/Ammonia | Amitech, Inc, |
| E-20602 | Proprietary Compound | High Point Textile |
| | | Auxiliaries |
| APEX 344-HC | Halogenated Compound/ | Apex Chemical |
| | Antimony Oxide | Corporation |
| HIPOFIRE BRA | Decabromodiphenyloxide/ | High Point Textile |
| | Antimonytrioxide | Auxiliaries |
| General | Monophosphate, diammonium | Assorted |
| Chemicals | phosphate, ammonium | manufacturers |
| | sulfamate, ammonium borate, | |
| | ammonium bromide, urea, | |
| | pentabromodiphenyl oxide, | |
| | chlorinated paraffin | |

According to embodiments of the present invention, the backing layer 14 comprises less than about 50% thermoplastic material, and preferably less than about 30% thermoplastic material. While Applicants expect that any sheet-like or fabric-like structure could be used, they have found that a spunlaced nonwoven fabric is well suited for this product. Spunlaced fabrics from DuPont under the trade name Sontara® or spunlaced fabrics from Polymer Group Inc. comprising woodpulp, rayon, Lyocell, or cotton as the cellulose portion of the product and polyester, nylon, or acrylic fiber as the minor blend component are exemplary. Alternatively, a wet-laid paper or nonwoven comprising at least 50% cellulosic fiber could be used. Alternatively, a needlepunched fabric comprising at least 50% non thermoplastic fiber could be used, and preferably at least 50% cellulosic fiber could be used.

According to embodiments of the present invention, the backing layer 14 has a Frazier air permeability at 0.5 inches of water column pressure drop (ASTM D737-96) of less than about 400 cfm (cubic feet per minute), and preferably less than about 100 cfm.

According to embodiments of the present invention, the backing layer 14 has a thickness of less than about 0.20 inches, and preferably less than about 0.10 inches.

According to embodiments of the present invention, thermal shrinkage of the backing layer 14 at 400° F. is less than about 35% in any direction, and preferably less than about 15% in any direction.

According to embodiments of the present invention, the backing layer 14 has a char length less than about nine inches (9 in.) when tested according to FTM-5903, and a thermal resistance rating of at least 1 when tested according to NFPA 2112.

The ticking layer 12, cushioning layer 16 and backing layer 14 may be bonded together in any of various ways. According to embodiments of the present invention, the ticking layer 12, cushioning layer 16 and backing layer 14 are quilted together with thread that forms spaced-apart patterns of stitches extending along the composite upholstery panel. According to embodiments of the present invention, the ticking layer 12, cushioning layer 16 and backing layer 14 are bonded together via ultrasonic bonding or welding, or via thermal point bonding. According to embodiments of the present invention, the ticking layer 12, cushioning layer 16 and backing layer 14 are adhesively bonded together.

According to embodiments of the present invention, composite upholstery panels as described above may be utilized in mattress construction. As illustrated in FIG. 2, a mattress 40 includes a mattress core 42 having opposite upper and lower portions 43, 44. The mattress core 42 may be constructed of a variety of resiliently compressible materials (e.g., springs, foam, etc.). Composite upholstery panels 10 overlie the mattress core upper portion and extend around a periphery of the mattress core, as illustrated. The composite upholstery panels 10 are attached along respective edge portions, as would be understood by those skilled in the art. Each composite upholstery panel 10 includes a layer of ticking fabric 12, a layer of flame and heat-resistant backing fabric 14, and a layer of resilient flame and heat-resistant cushioning material 16 sandwiched between the layer of ticking fabric 12 and the layer of backing fabric 14 as described above with respect to FIG. 1. The upper and side composite upholstery panels each maintain flame and heat resistant integrity when impinged at any location with a gas flame in accordance with testing protocol set forth in TB-603. However, individually, the ticking layer 12, backing layer 14 and cushioning layer 16 would fail to maintain flame and heat resistant integrity when impinged with a gas flame in accordance with testing protocol set forth in TB-603.

### EXAMPLES

Two control panels were prepared. The first panel was a 9.6 ounces per square yard (OSY) needlepunched fabric that was formed from 80% Visil fiber and 20% modacrylic fiber. The Visil fiber is from Sateri OY of Finland and the Modacrylic is Protex PBX from Kaneka Corp. of Japan. The second panel was made with of the same composition with a basis weight of 6.4 oz/sy.

To test the performance of the material, a 12″×12″ panel of the test sample was placed atop a 2 inch thick panel of urethane cushioning foam. A thermocouple was positioned behind the fabric barrier between the foam and fabric. The panel was suspended in a laboratory hood, and exposed to the flame from a California TB129 burner, for three (3) minutes. The temperature behind the barrier was measured over the three minute test, particularly noting the temperatures at 50 and 70 seconds and the peak temperature. Additionally, observation was made as to whether the sample allows ignition of the foam, or cracks open from the thermal stress.

The following samples were prepared:
1. A 2.25 OSY spunlaced fabric composed of 55% woodpulp and 45% polyester was finished with a nondurable salt type phosphate flame retardant (Spartan FR880).
2. A 2.0 OSY spunlaced fabric composed of 55% woodpulp and 45% Lyocell fiber was finished with 0.95 OSY of a blend of Ammonium Polyphosphate and binder. (Noveon 3882).
3. A 2.0 OSY spunlaced fabric as in #2, was coated with 1.73 OSY of Noveon 3871 B, which is a blend of 11% expandable graphite and 89% binder.
4. A 3.5 OSY needle punched fabric composed of 70% Lyocell and 30% Polyester was finished with 2.19 OSY of Noveon 3882.
5. A 3.25 OSY needle punched fabric as in #4 was coated with 1.13 OSY of Noveon 3871B.
6. A 3.5 OSY needle punched fabric as in #4 was coated with 1.3 OSY of Unibond 1657, a blend of acrylic binder and Ammonium polyphosphate.
7. The fabric of #1 was coated with 1.6 OSY of Noveon 3871B.
   A panel was prepared using each fabric in samples 1-7 above combined with 6.4 OSY needlepunched control fabric. The results are as follows:

| | Temp C. | Temp C. | Peak |
|---|---|---|---|
| Sample # | at 50 sec | at 70 sec | Temp C. |
| 1. | 155 | 215 | 400 |
| 2 | 164 | 211 | 397 |
| 3. | 85 | 150 | 350 |
| 4. | 133 | 190 | 397 |
| 5. | 132 | 199 | 374 |
| 6 | 125 | 185 | 389 |
| 7 | 112 | 168 | 372 |
| Control, 9.6 osy | 169 | 241 | 411 |
| Control, 6.4 osy | 280 | 327 | 437 |

In each case, the combination of the backing layer and the lesser amount of fibrous barrier gave better results than the control. These combinations give a thinner and more manageable composite upholstery panel, as well as improved flame response. In addition, the polypropylene backing fabric, typically used in common manufacturing methods, is eliminated which reduces the cost.

That which is claimed is:

1. A mattress, comprising:
a mattress core having opposite upper and lower portions;
an upper composite upholstery panel overlying the mattress core upper portion; and
a side composite upholstery panel extending around a periphery of the mattress core, wherein the side composite upholstery panel is attached along an edge portion to the upper composite upholstery panel;
wherein the upper and side composite upholstery panels each comprise a three layer composite:
a layer of ticking fabric that comprises a knit or woven textile and that fails to maintain flame and heat resistant integrity when impinged individually with a gas flame in accordance with testing protocol set forth in Technical Bulletin 603 of the State of California Department of Consumer Affairs (TB-603);
a layer of backing fabric, wherein the backing layer has a thickness of less than 0.20 inches and comprises spunlaced, wet-laid or needlepunched fabric comprising at least 50% cellulosic fiber, wherein the spunlaced, wet-laid or needlepunched fabric is treated with a flame retardant comprising borates, sulfamates, phosphates, organic phosphorous compounds, halogenated compounds and antimony compounds, and wherein the layer of backing fabric fails to maintain flame and heat resistant integrity when impinged individually with a gas flame in accordance with testing protocol set forth in TB-603; and
a layer of resilient cushioning material comprising a fibrous material or a foam material sandwiched between the layer of ticking fabric and the layer of backing fabric, wherein the cushioning material fails to maintain flame and heat resistant integrity when impinged individually with a gas flame in accordance with testing protocol set forth in TB-603;
wherein the combination of the ticking layer, backing layer and cushioning layer in the composite upholstery panel synergistically maintains flame and heat resistant integrity when impinged at any location with a gas flame in accordance with testing protocol set forth in TB-603.
